(19) United States
(12) Patent Application Publication
(10) Pub. No.: US 2012/0025544 A1
(43) Pub. Date: Feb. 2, 2012

(54) Multiple point door locking system, with handle turning direction control

(75) Inventor: Alan K. Uyeda, Irvine, CA (US)

(73) Assignee: ADAMS RITE MANUFACTURING CO.

(21) Appl. No.: 13/317,050

(22) Filed: Oct. 11, 2011

Related U.S. Application Data
(63) Continuation-in-part of application No. 12/384,948, filed on Apr. 10, 2009.
Application No. 12/384,948 is a continuation of application No. 12/393,140, filed on Feb. 26, 2009, now Pat. No. 7,847,670.

(51) Int. Cl. E05C 1/10

(52) U.S. Cl. 292/145

(57) ABSTRACT

A locking system enabling selectively handed handle turning as for unlocking a door, comprising in combination, drive means including said handle rotatable clockwise and counterclockwise, driven means including a part movable linearly in a primary direction, to operate door lock structure, and coupling means including a handle rotation direction selector having first and second alternate positions, and operable to displace said part in said primary direction in response to handle clockwise rotation when the selector is in first position, and alternatively to displace said part in said primary direction in response to handle counterclockwise rotation when the selector is in second position, as for example in relation to two parallel racks.

This application is a continuation-in-part of pending U.S. application Ser. No. 12/384,948, filed Apr. 16, 2009, entitled MULTIPLE POINT DOOR LOCKING SYSTEM, WITH HANDLE TURNING DIRECTION CONTROL, which is a continuation of Ser. No. 12/393,140, filed Mar. 20, 2009, and entitled “MULTIPLE POINT DOOR LOCKING SYSTEM”, which is incorporated herein by reference.

### BACKGROUND OF THE INVENTION

There is need for simple, highly compact, durable and efficient door locking and unlocking devices, where deadbolts and latches are to be operated, as from the inner and outer sides of doors. In particular, there is need for improvements in mechanism responsive to door handle turning, and incorporating means enabling handle positioning for selective handed turning, clockwise or counterclockwise. One example enables selected direction handle turning at the door inner side, with mechanism responsive to door unlocking at the door inner side, to secure door unlatching.

### SUMMARY OF THE INVENTION

It is a major object of the invention to provide improvements in apparatus meeting the above needs.

Basically, a locking system enabling selectively handed (right or left) handle turning, incorporating the invention, includes:

a) drive means including the handle rotatable clockwise and counterclockwise,

b) driven means including a part movable linearly in a primary direction, to operate door lock structure,

c) and coupling means including a handle rotation direction selector having first and second alternate positions, and operable to displace said part in said primary direction in response to handle clockwise rotation when the selector is in first position, and alternatively to displace that part in the primary direction in response to handle counterclockwise rotation, when the selector is in second position.

As will be seen, such structure and functioning enables or facilitates door installation and operation for unlocking operation, by turning to handle either clockwise or counterclockwise, with the basic mechanism of the lock structure remaining unchanged.

Another object includes provision of such coupling to include two coupling racks, one of which is operatively coupled to the driven part when the handle is rotated clockwise, and the other of which is operatively coupled to the driven part when the handle is rotated counterclockwise. As will be seen, the selector is alternatively coupled to one or the other of two coupling racks, characterized in that the non-coupled rack remains inactive when the coupled rack is displaced in said direction in response to handle rotation, for either direction of such rotation.

A further object includes provision of the driven means to include a linearly movable lock actuating member to which one or the other of the racks is coupled by the selector. As will be seen, the selector may comprise a connector such as a pin, easily shifted between alternate positions of rack coupling to the lock actuating member, as at the time of lock system installation. The uncoupled rack typically “floats” inactively during coupled rack displacement. Yet another object includes provision of such racks to be separately movable in parallel relation, at opposite sides of a rack engaging gear driven by handle rotation.

An additional object includes provision of the selector in the form of a connector shiftable between alternate positions of rack coupling to the lock actuating member, as at the time of lock system installation.

Yet another object includes provision of that member in the form of a linearly movable plate incorporating a further rack operatively coupled to a driven gear that operates door locking and unlocking mechanism. The two coupling racks, the further rack, and the plate are typically longitudinally vertically oriented for movement longitudinally, in compact, efficient aligned relation, for door mounting. Return spiral serve to urge the plate and its driving rack upwardly.

In accordance with a further aspect of the invention, the structure as referred to, may be efficiently incorporated in a multi-function door lock system comprising:

a) a frame having opposite sides, and installable on a door openable between an interior space and an exterior space,

b) a deadbolt and a door latch carried by the frame to move between retractable and extended positions,

c) a first rotary control located at one level on the frame to control deadbolt movement between extended and retracted positions via primary cam mechanism,

d) a second rotary control, operated by the handle or handles, at another level on the frame to control latch movement between extended and retracted positions, via secondary cam mechanism,

e) means operatively connected between the secondary cam mechanism and the primary cam mechanism to effect deadbolt movement as aforesaid, in response to operation of the second rotary control, as effected via rotary input to the second rotary control from only one side of the frame.

In this regards, objectives and structure defined in said Ser. No. 12/393,140, are incorporated herein by reference.

These and other objects and advantages of the invention, as well as the details of an illustrative embodiment, will be more fully understood from the following specification and drawings, in which:

### DRAWING DESCRIPTION

FIGS. 1-33 are incorporated by reference from said Ser. No. 12/393,140;

FIG. 34 is an elevation showing structure incorporating the invention;

FIG. 35 is a perspective exploded view of preferred apparatus incorporating the invention;

FIG. 36 is an enlarged vertical elevation showing elements including racks and gears shown in FIG. 34, and a door handle turnable clockwise to unlock the door, in response to activation of one of two parallel racks;

FIG. 36a shows the handle of FIG. 34 in relation to a door installation;

FIG. 37 is a view like FIG. 36, with the door handle turnable counterclockwise to activate the other of the two parallel racks;

FIG. 37a shows the handle of FIG. 37 in relation to a door installation;

FIG. 38 is a section taken on lines 38-38 of FIG. 37.

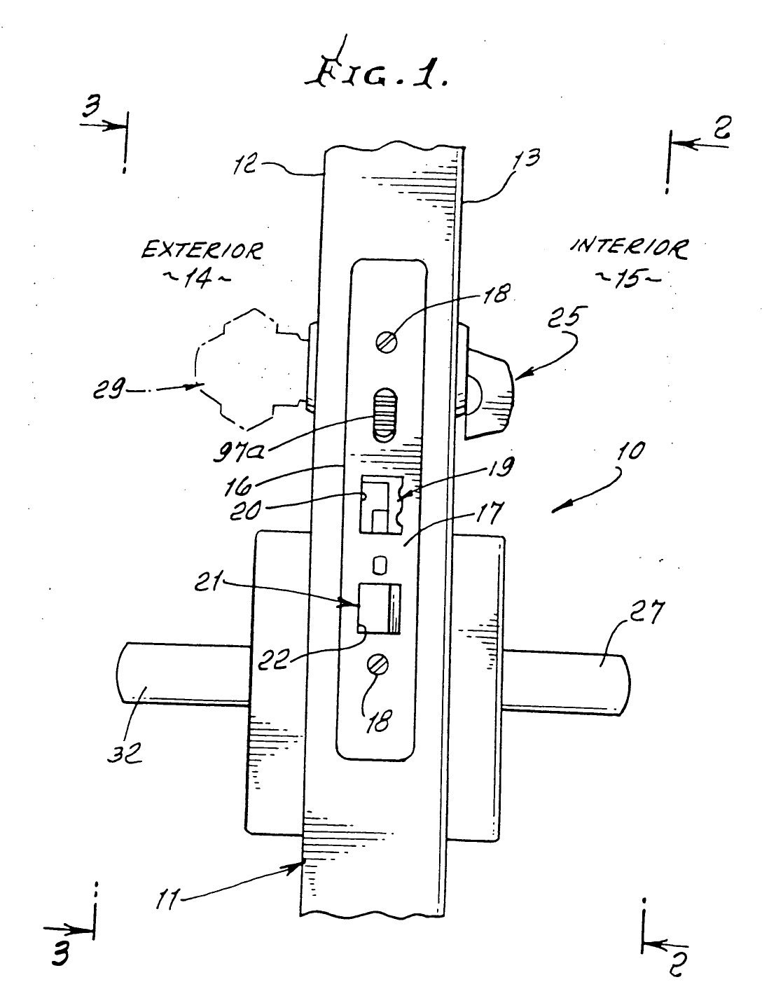

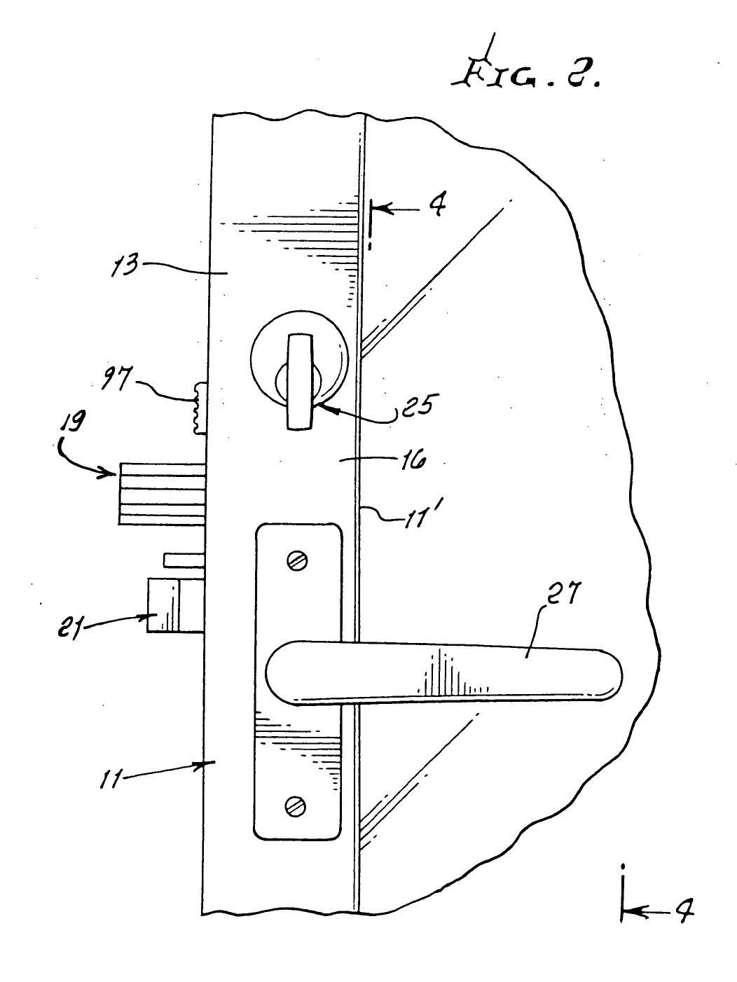

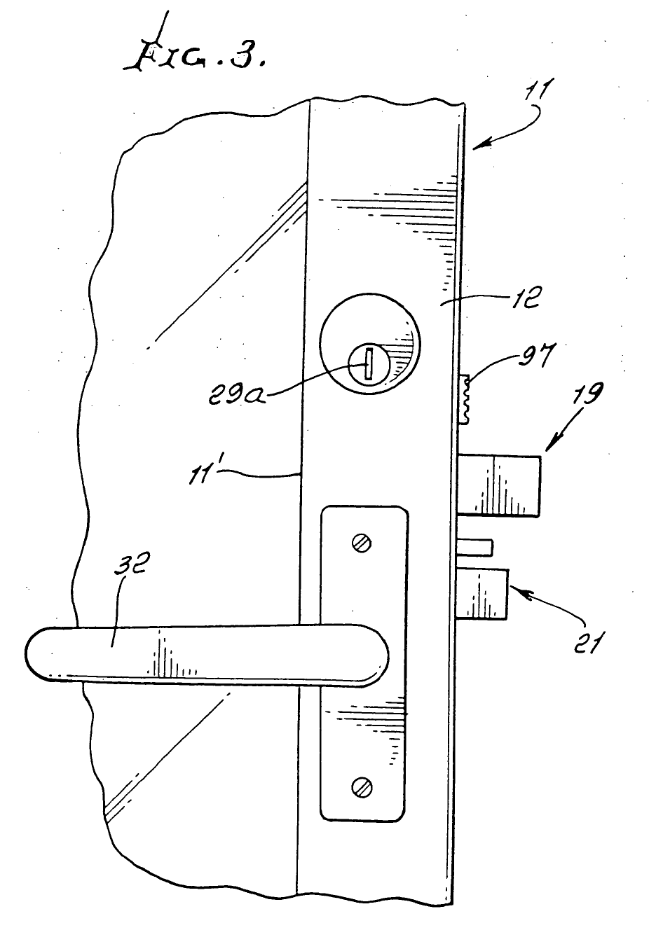

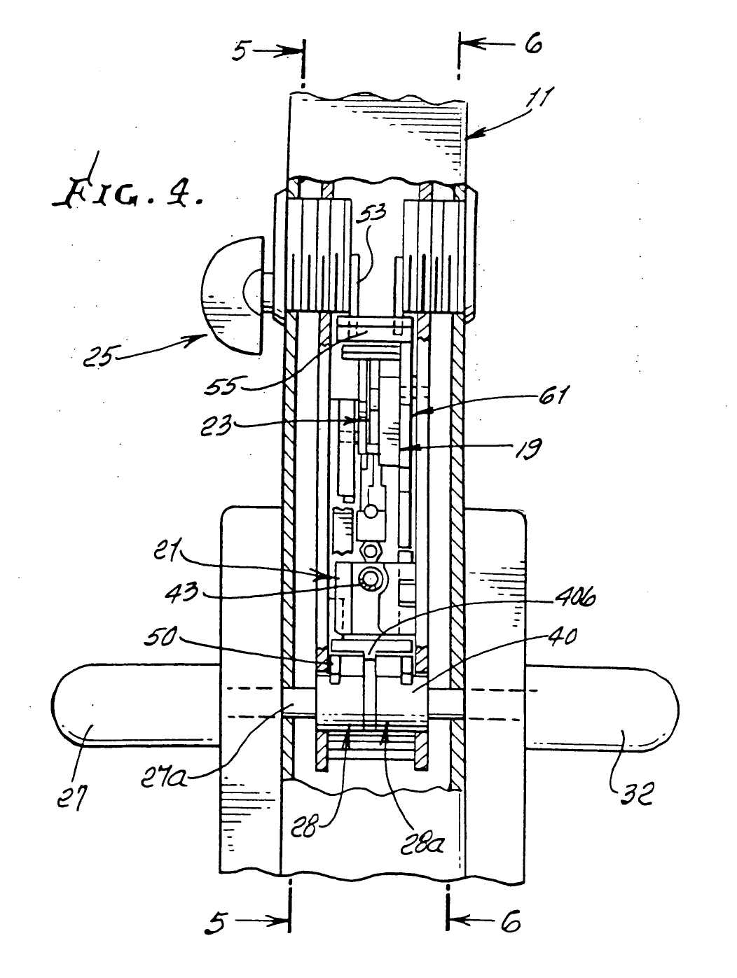

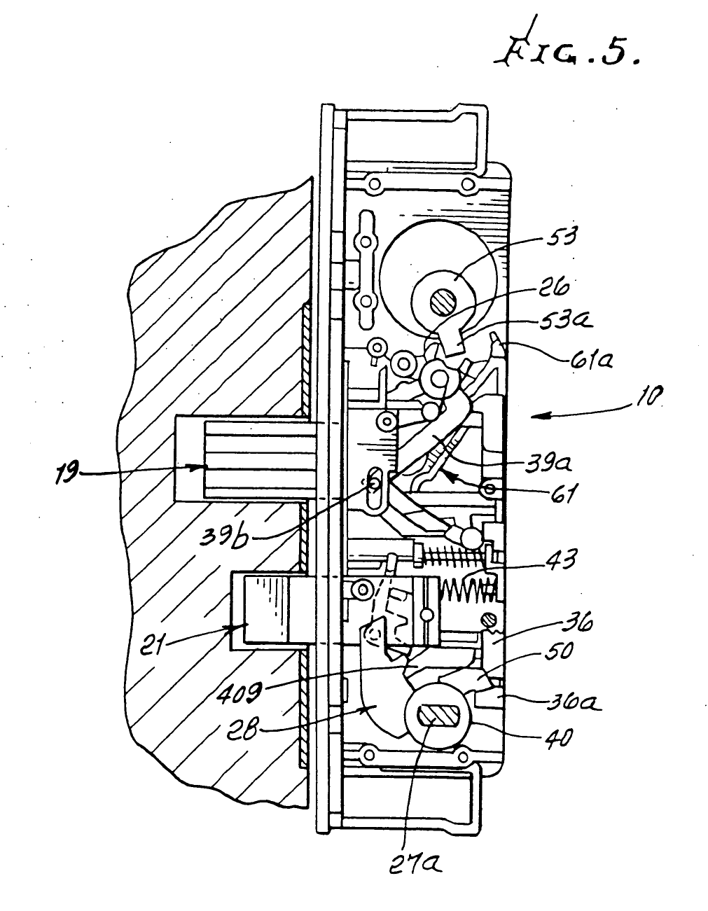

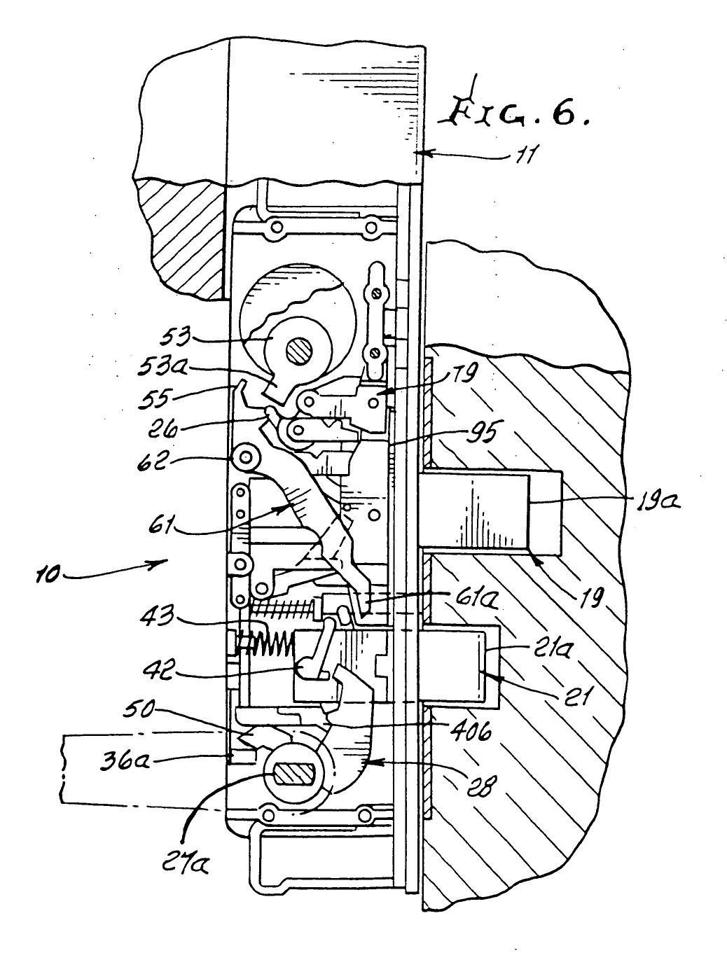

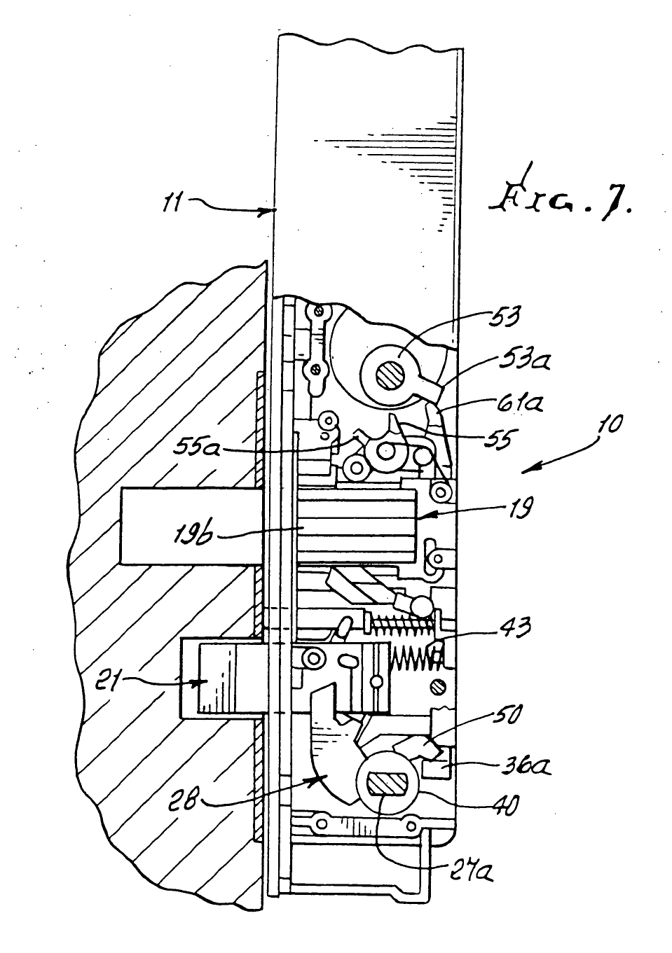

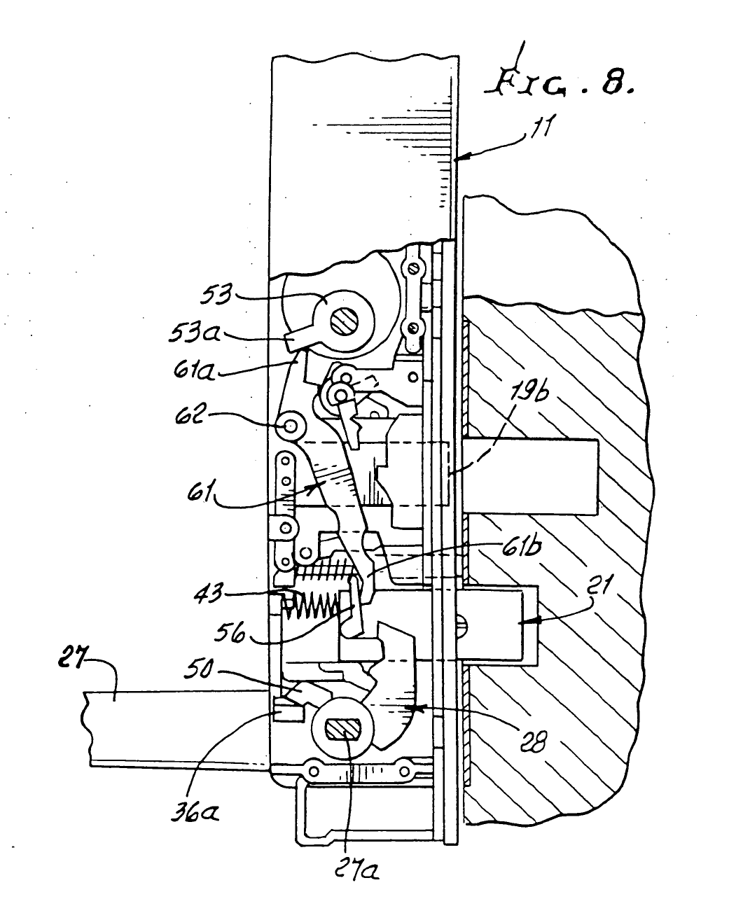

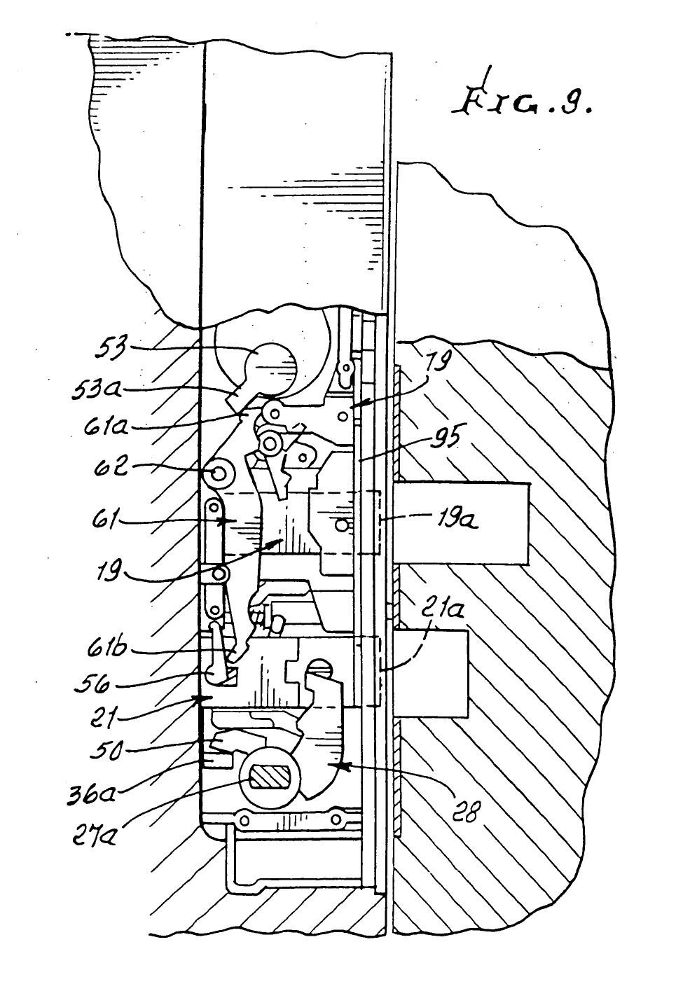

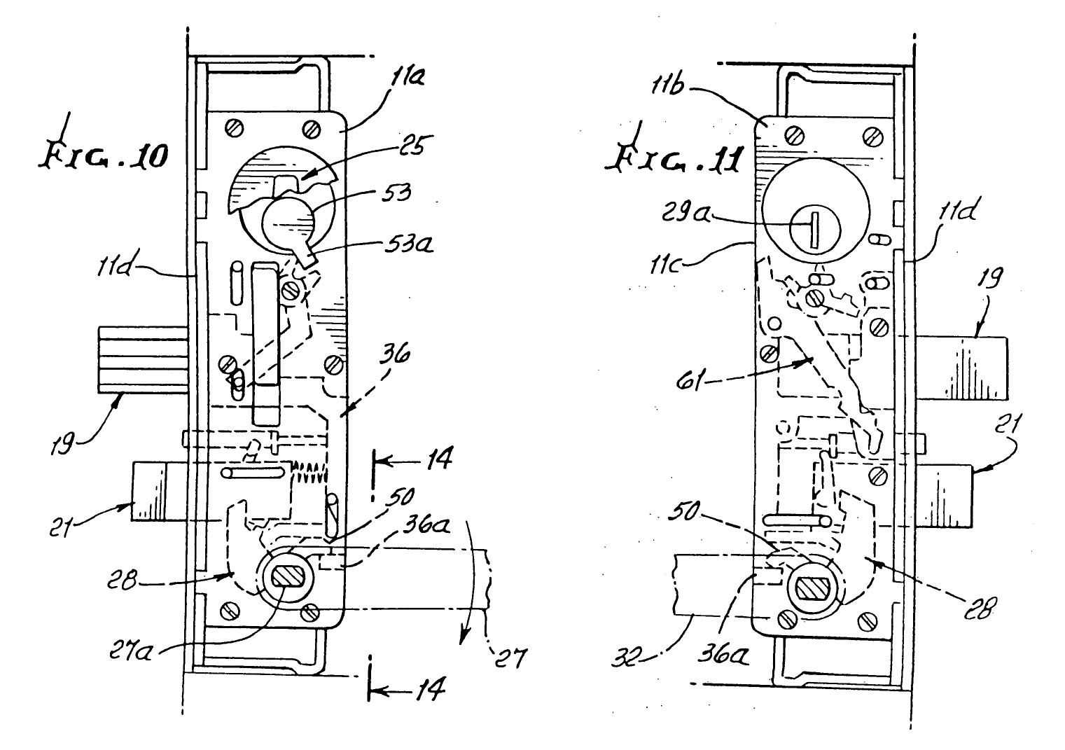

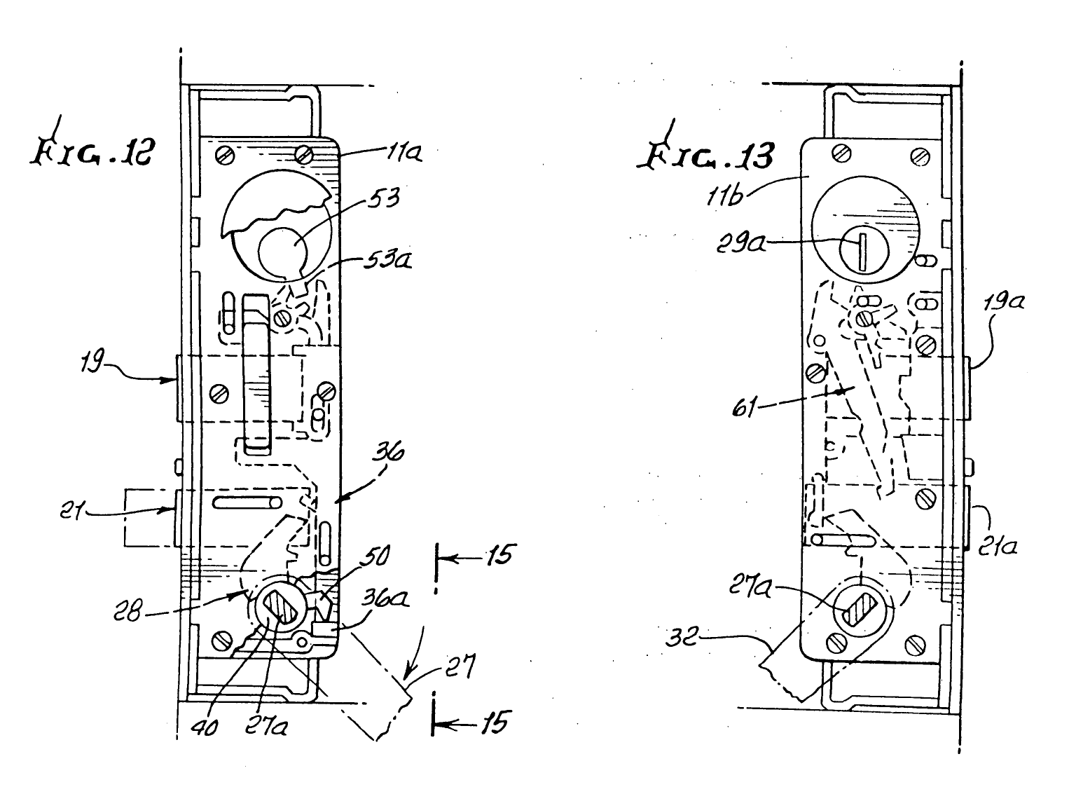

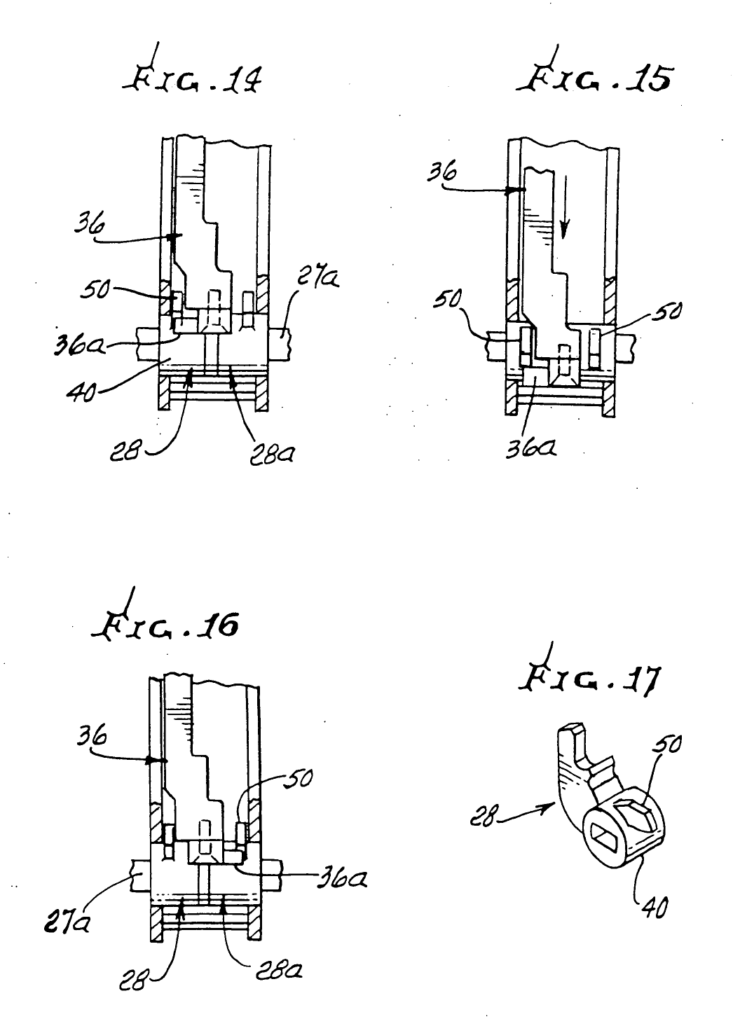

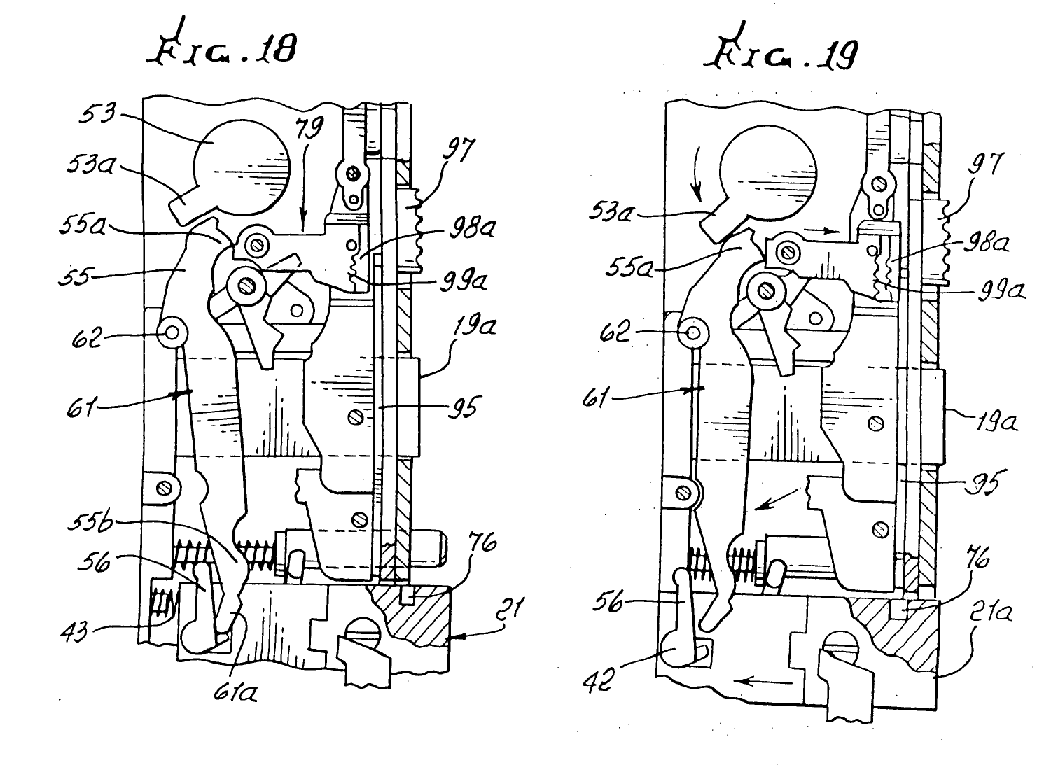

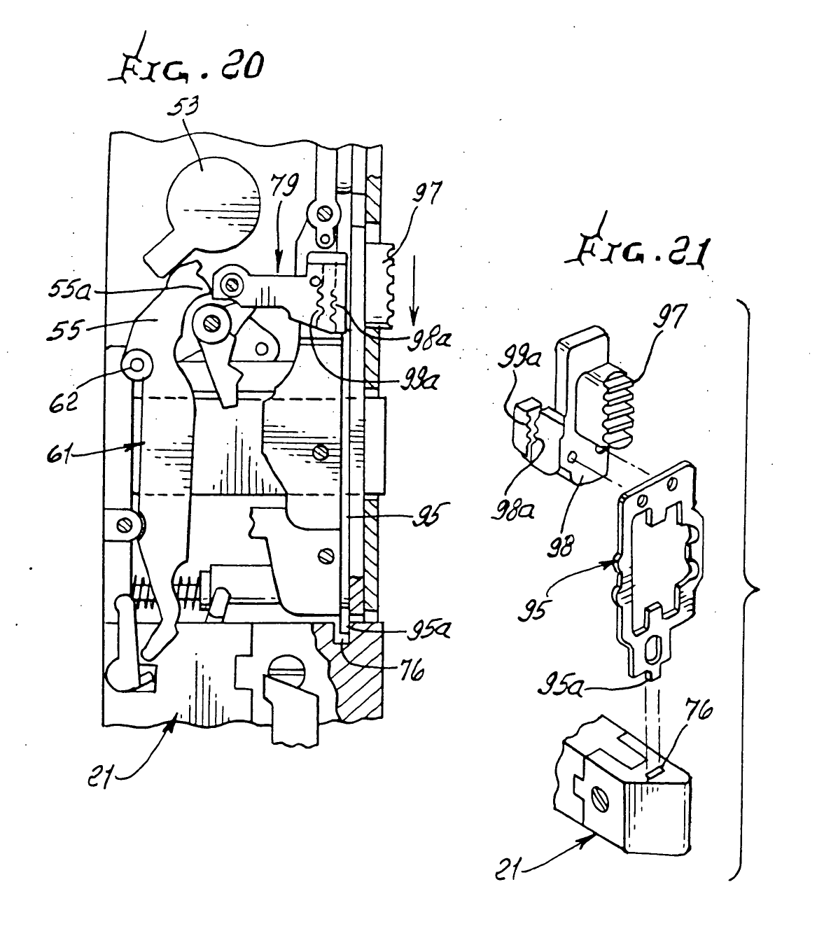

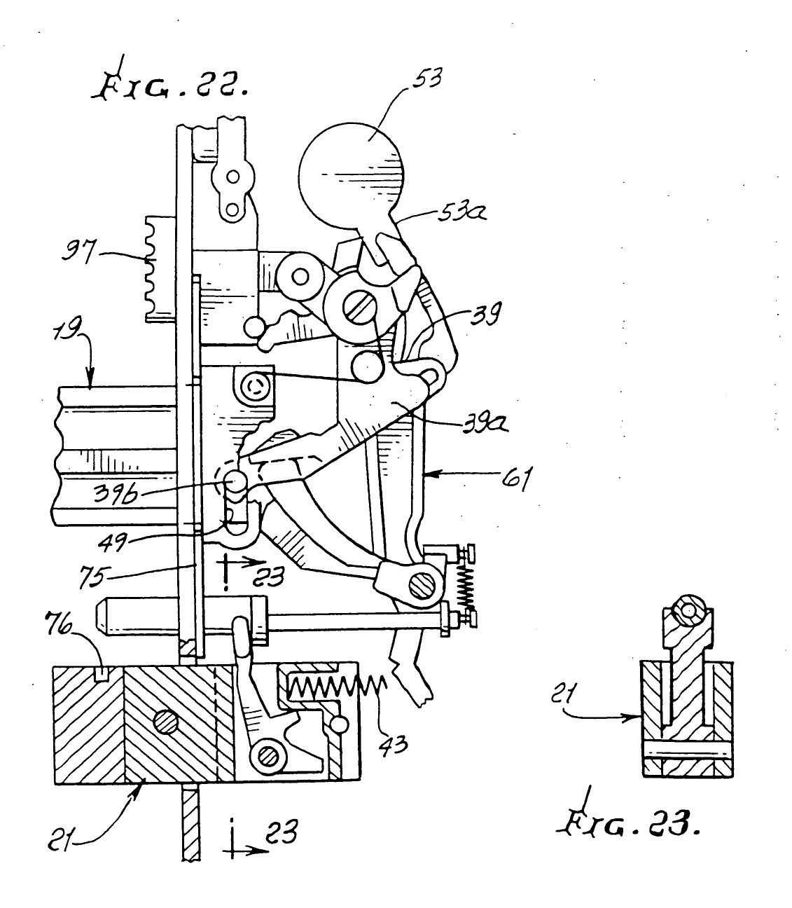

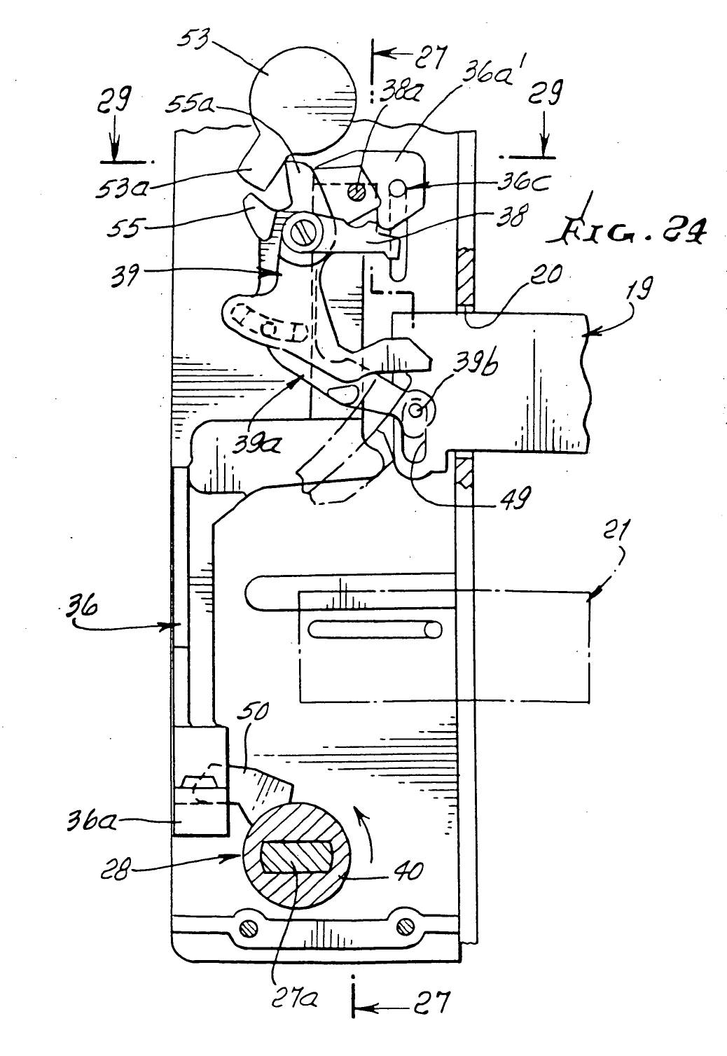

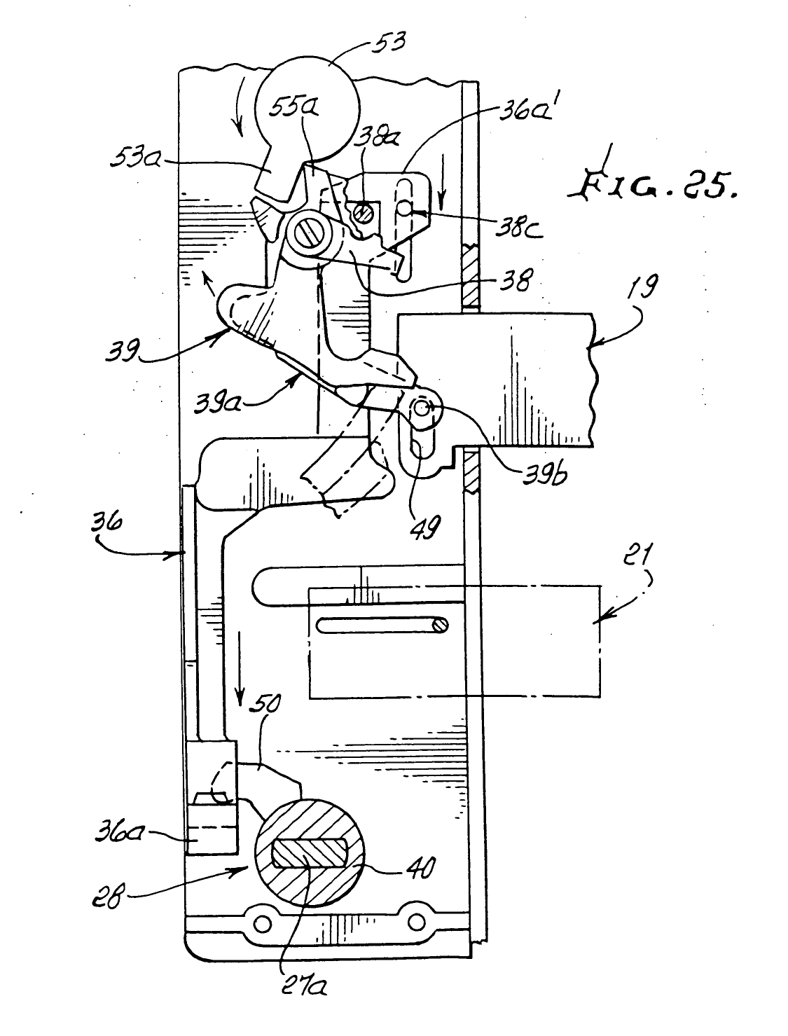

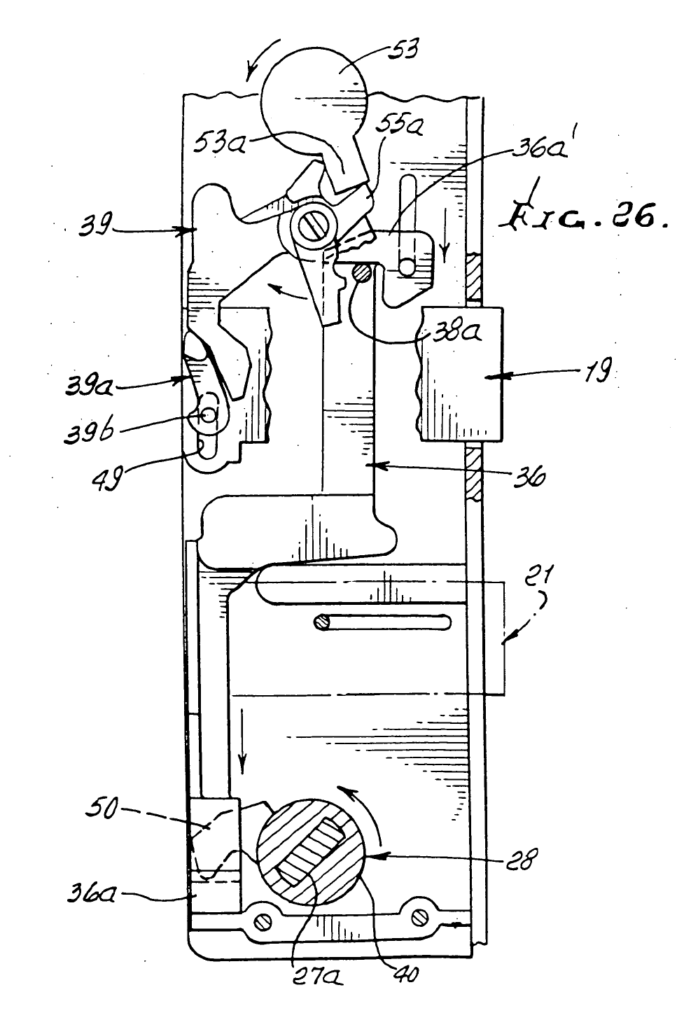

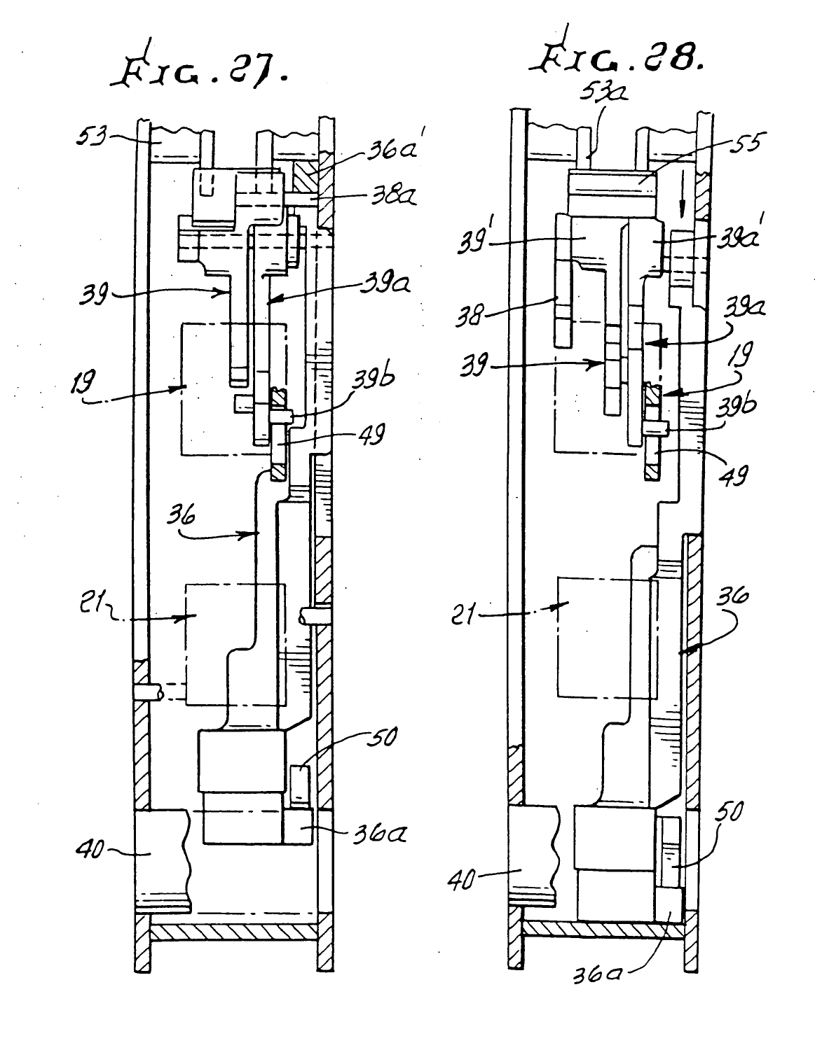

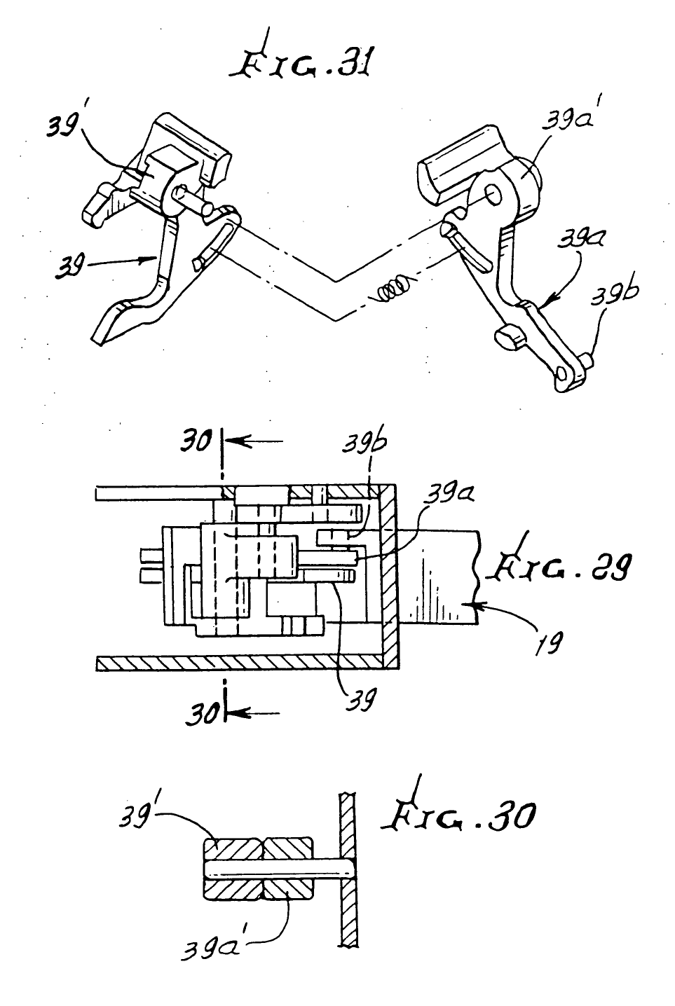

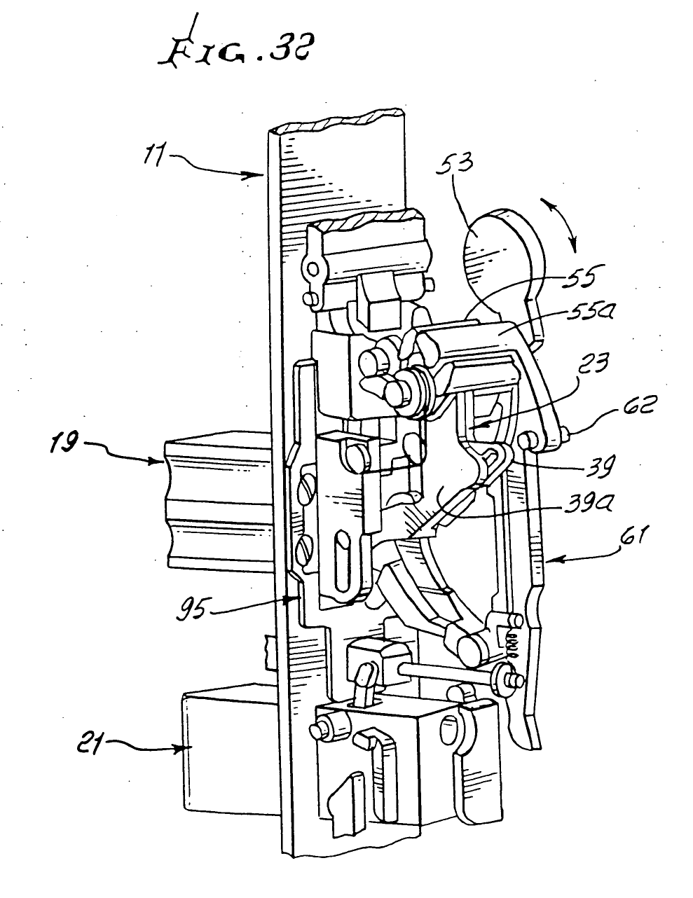

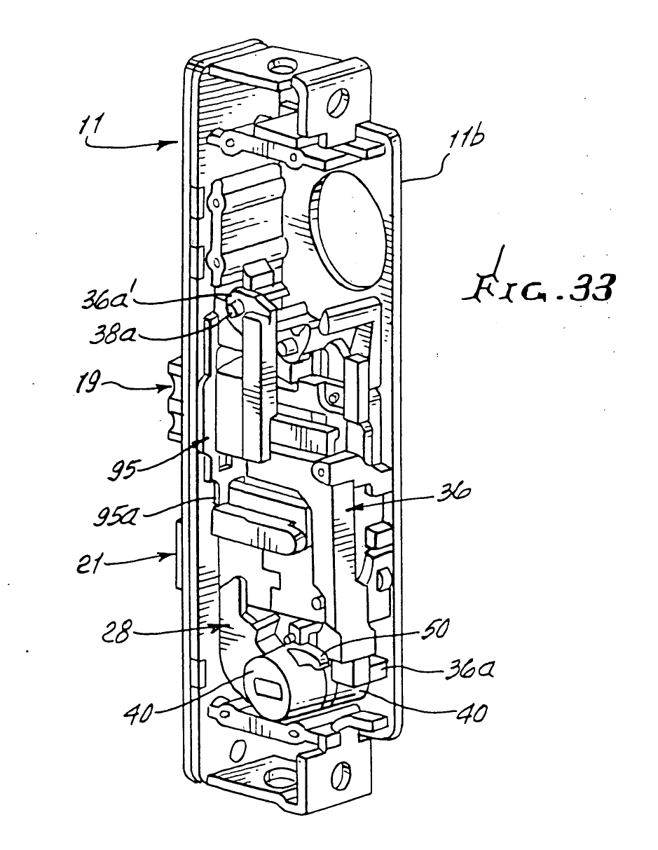

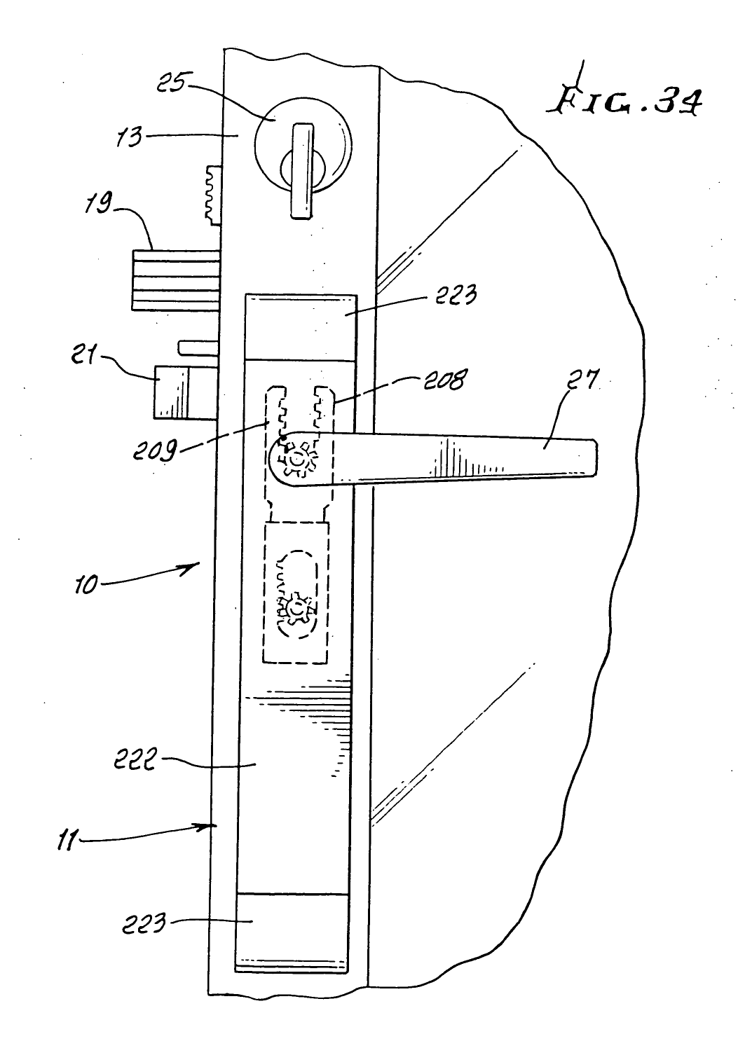

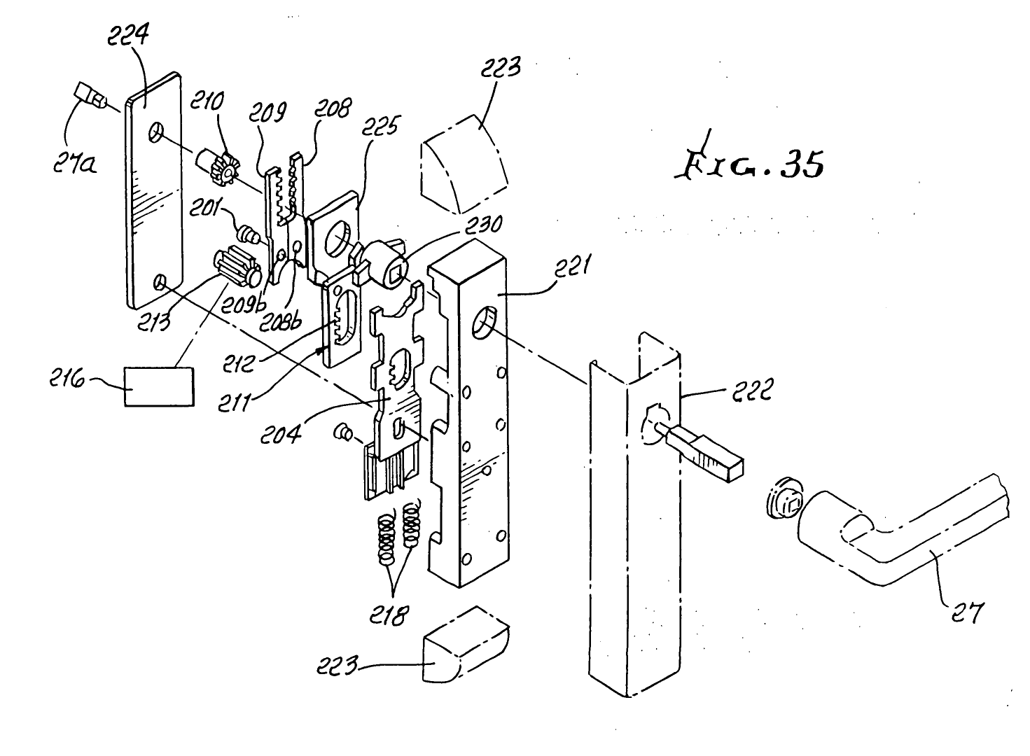

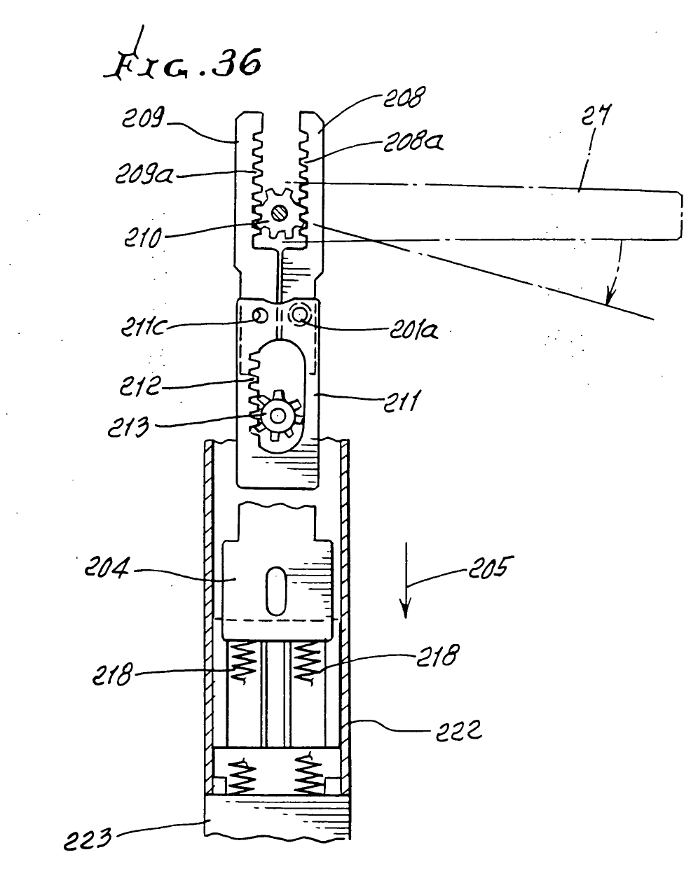

### DETAILED DESCRIPTION

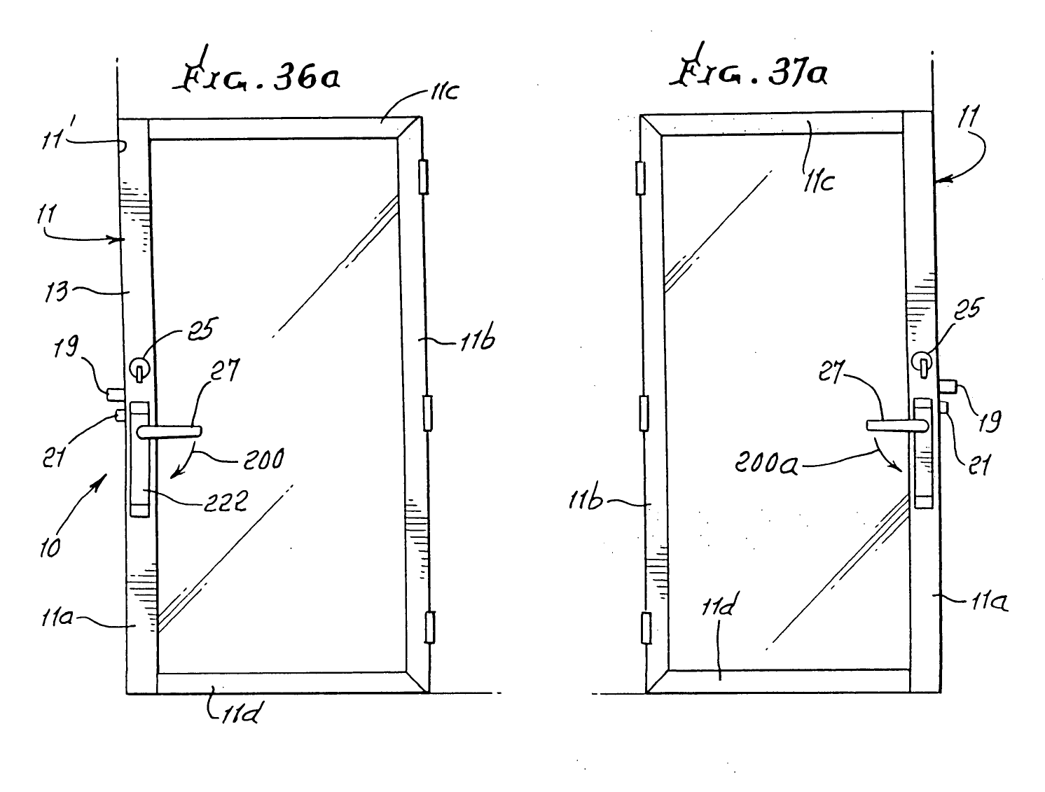

In FIG. 36a, a preferred door lock system or apparatus 10, has a mounting frame 11 sized for insertion into a door opening 11′.

The frame has opposite sides which respectively face toward the door exterior, and the door interior. See side 13 facing the door interior. As seen in FIG. 36a a deadbolt 19 is carried by the frame to move between extended position and retracted positions in the frame; and a latch bolt or latch 21 is carried by the frame below 19, to protrude as it is moved between extended position and retracted positions in the frame. Elongated frame structure appears at 11a . . . 11d.

A first rotary control such as rotary actuator 25 is located at one level on the frame, at the interior side of the door, for example, to control deadbolt movement between extended and retracted positions via compact mechanism in the frame. Actuator 25 is typically gripped by the user's thumb and finger, to be turned in operating the deadbolt. A second rotary control, such as handle 27 is located at a second and typically lower level, to project from the frame, at the interior side of the door, for example, to control latch 21 movement between extended and retracted positions via compact mechanism in the frame, that mechanism typically including secondary cam mechanism.

A key projects at the exterior side of the door, i.e. opposite from rotary actuator 25, to be operatively connected with the first rotary control for moving the deadbolt (as between extended or locking position, and a retracted or unlocking position). Also a second handle or handle lever typically projects at the exterior side of the door, and at the opposite side of the frame from handle 27. That handle is operatively connected with second rotary control mechanism, as is handle 27, to control latch 21 movement between extended and retracted positions, in response to manual down-turning of handle, at the exterior side of the door.

Latch movement between extended and retracted positions occurs in response to turning of either of such handles effected via compact secondary cam mechanism.

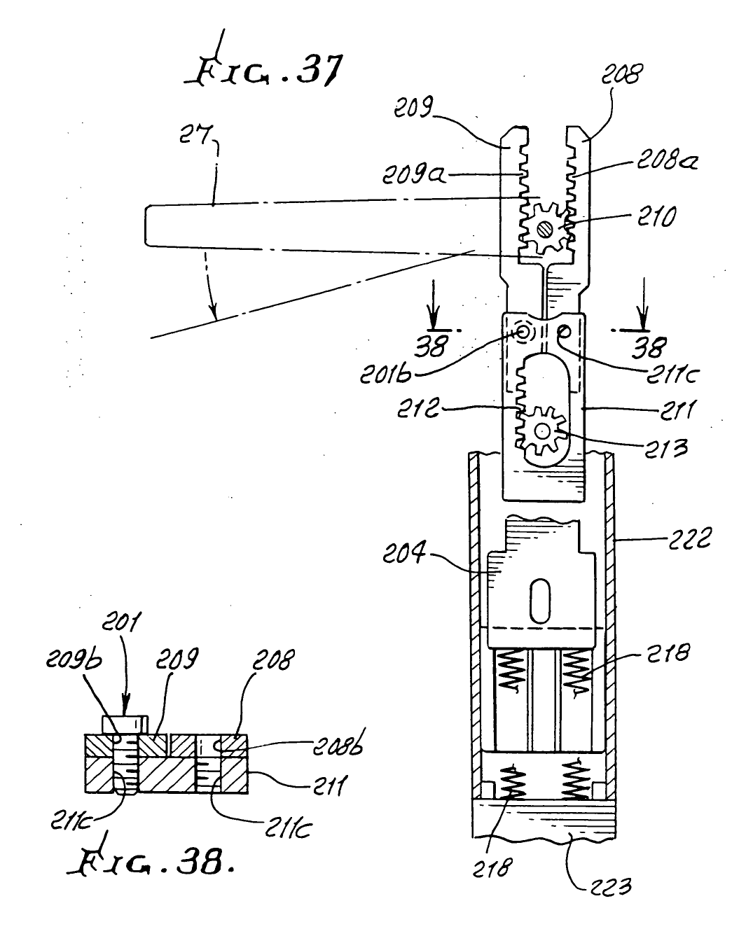

It is a feature of the invention that the door installation may accommodate either right-handed i.e. clockwise down movement of handle 27 (see arrow 200 in FIG. 36a) to operate the latch, or left-handed i.e. counterclockwise down movement of handle 27 (see arrow 200a in FIG. 37a) to operate the latch (i.e. retract it from a latch captivating recess in the door opening). This is accomplished with re-setting or re-positioning of only one element, such as a selector, i.e. connector pin 201 seen in FIGS. 35-37. In other words, the system enables selectively handed (right or left) handed turning of a handle for unlocking (unlatching) of a door, as at the time of door installation.

As referred to, a drive means includes handle 27 rotatable clockwise and counterclockwise; a driven means that typically includes a driven part, such as linearly movable lock actuating member or link plate 204, linearly movable in a primary direction (see arrow 205) to operate door lock structure; and coupling means is provided and includes the handle rotation direction selector pin 201. That pin has first and second alternate positions 201a and 201b (see FIGS. 36 and 37), whereby it operates to displace part or plate 204 in direction 205 in response to handle clockwise rotation (see FIG. 36) when the selector pin is in a first position, and alternatively it operates to displace 204 in the primary direction 205 in response to handle counterclockwise rotation (see FIG. 37) when the pin is in its second position.

This is accomplished in an efficient, laterally compact, and vertically longitudinally elongated or disposed positioning of elements, by providing two vertically elongated coupling racks 208 and 209, one of which is operatively coupled to the driven part 204 when the handle is turned clockwise (see FIG. 36), and the other of which is operatively coupled to the driven part 204 when the handle is rotated counterclockwise (see FIG. 37). Accordingly, the selector pin or screw is alternatively coupled to one or the other of the coupling racks, in such manner that the non-coupled rack remains inactive when the coupled rack is displaced in direction 205 in response to handle rotation. Further, the non-coupled rack “floats”, i.e. moves upwardly as the selector coupled rack moves downwardly. See rack teeth 208a and 209a engaging opposite sides of toothed rotary drive element or gear 210 rotated by handle 27 via drive cam 230. Pin is manually positioned in either FIG. 36 or FIG. 37 position, at the time of installation. It is received in drilled opening or hole 208b in rack 208, and hole 211b in plate 211; or in hole 209b in rack 209 and hole 211c in plate 211. In either event, plate 211 is displaced downwardly in response to handle turning. Note 211 is coupled to link plate on member 204.

Plate 211 incorporates a further rack 212 operatively coupled to a driven spur gear 213, that operates door unlocking mechanism indicated at 216 as plate 204 moves downwardly. Return springs 218 serve to push plate 204 back upwardly, and its driving rack (208 or 209) back upwardly returning handle 27 to horizontal position.

The invention may be efficiently incorporated in the locking system of Ser. No. 12/393,140, that comprises

a) a frame having opposite sides, and installable on a door openable between an interior space and an exterior space,

b) a deadbolt and a door latch carried by the frame to move between retractable and extended positions,

c) a first rotary control located at one level on the frame to control deadbolt movement between extended and retracted positions via primary cam mechanism,

d) a second rotary control, operated by the handle or handles, at another level on the frame to control latch movement between extended and retracted positions, via secondary cam mechanism,

e) means operatively connected between the secondary cam mechanism and the primary cam mechanism to effect deadbolt movement as aforesaid, in response to operation of the second rotary control, as effected via rotary input to the second rotary control from only one side of the frame.

Housing and mounting elements appear at 221-223 in FIG. 35, along with a mounting plate 224 and a vertical displacement guide 225 for 211.

I claim:

1. A locking system enabling selectively handed handle turning as for unlocking a door, comprising in combination:
a) drive means including said handle rotatable clockwise and counterclockwise,
b) driven means including a part movable linearly in a primary direction, to operate door lock structure,
c) and coupling means including a handle rotation direction selector having first and second alternate positions, and operable to displace said part in said primary direction in response to handle clockwise rotation when the selector is in said first position, and alternatively to displace said part in said primary direction in response to handle counterclockwise rotation when the selector is in said second position.

2. The combination of claim 1 wherein said coupling means typically include two coupling racks, one of which is operatively coupled to the driven part when the handle is rotated clockwise, and the other of which operatively coupled to the driven part when the handle is rotated counterclockwise.

3. The combination of claim 2 wherein the selector is alternatively coupled to one or the other of two coupling racks, whereby the non-coupled rack remains inactive when the coupled rack is displaced in said direction in response to handle rotation.

4. The combination of claim 3 wherein said part includes a linearly movable lock actuating member to which one or the other of the racks is coupled by said selector.

5. The combination of claim 4 wherein said selector comprises a connector shiftable between alternate positions of rack coupling to the lock actuating member, as at the time of lock system installation.

6. The combination of claim 2 wherein the racks are separately movable in parallel relation, at opposite sides of a rack engaging gear driven by handle rotation.

7. The combination of claim 4 wherein said member comprises a linearly movable plate incorporating a further rack operatively coupled to a driven gear that operates door locking and unlocking mechanism.

8. The combination of claim 7 wherein the two coupling racks, and said further rack are longitudinally vertically oriented, in compact relation.

9. The combination of claim 2 wherein the non-coupled rack is located to move upwardly as the non-coupled rack moves downwardly.

10. The combination of claim 9 wherein the two racks are located to face one another laterally during rack movement, longitudinally.

11. The combination of claim 10 including a plate selectively coupled to one of the two racks to be displaced downwardly in response to handle turning.

12. The combination of claim 11 including door unlocking mechanism operatively coupled to said plate to be operated as the plate is moved downwardly.

13. The combination of claim 12 including return springs positioned to urge said plate and its driving rack upwardly.
